(19) United States
(12) Patent Application Publication
(10) Pub. No.: US 2014/0095596 A1
(43) Pub. Date: Apr. 3, 2014

(54) SYSTEM AND METHOD FOR LONG-LIVED CONTEXTUAL INTERACTIONS

(71) Applicant: AVAYA INC., Basking Ridge, NJ (US)

(72) Inventor: Neil Ashok Kumar Singh, Pune (IN)

(73) Assignee: AVAYA INC., Basking Ridge, NJ (US)

(21) Appl. No.: 13/629,977

(22) Filed: Sep. 28, 2012

(51) Int. Cl. G06F 15/16

(52) U.S. Cl. 709/204

(57) ABSTRACT

System and method to preserve a long-lived interaction, the method including: participating, by use of a communication medium, in a present communication session with a remote party; associating, by use of a processor, a present identification tag with the present communication session; associating, by use if a processor, contextual information with the present identification tag, wherein the contextual information provides context of the present communication session; and storing, by use if a processor coupled to a memory, a record of the present identification tag and contextual information beyond conclusion of the present communication session, wherein the stored present identification tag and stored contextual information form the long-lived interaction. The method may further include searching a memory for previous identification tags of previous communication sessions with the remote party; and selecting, from a search result, a previous identification tag for use as the present communication tag.

### BACKGROUND

1. Field of the Invention

Embodiments of the present invention generally relate to a series of related interactions (e.g., telephone calls), and, in particular, to a system and method for preserving a context of interactions during the series of related interactions.

2. Description of Related Art

Telecommunications terminals such as a smartphone are unable to preserve a context of long-term, ongoing interactions (e.g., telephone calls) with persons that the caller may be interacting with repeatedly. Presently, when another interaction takes place, the participants usually must come to a common understanding of the status of their discussions the last time they communicated, including any agreements made. Any contextual information that exists about the interactions may have been stored in an ad-hoc manner by users, and not necessarily linked to the interactions themselves. Therefore, if a user wanted to find reference material related to the interaction, the user would have to search for it separately in an unstructured or uncontrolled storage. There would be no automatic linkage between the interaction and associated contextual data.

US Patent Publication No. US 2011/0202867 (“the '867 publication”) discloses a system that delivers customer data to a customer service agent upon a communication event such as an incoming call. The '867 publication is specific to a centralized system that records information in a contact center for later presentation to an agent at a terminal. It does not provide both parties in a conversation an ability to link contextual information across a continuous series of interactions.

US Patent Publication No. 2006/0153357 (“the '357 publication”) discloses a method to provide dynamic contextual information with contextual information (e.g., caller ID information) embedded in the telephone calls by way of SIP messages. The '357 publication describes transferring contextual information to the endpoints to which the call traverses. The '357 publication does not disclose linking contextual information across a series of interactions between the caller and the callee. Furthermore, the '357 publication discloses embedding contextual data about the caller in a SIP message, thereby limiting the type and quantity of contextual information to information that can be represented in a SIP message. Large files and different types of data cannot be accommodated by the disclosure of the '357 publication.

A capability to automatically record the context of interactions would be useful, particularly when the interactions are based on a same or similar subject. Having access to the context of previous calls would make later calls more efficient and consistent, because there would be no need to revisit subject matter already discussed, and consistent decisions can be made.

Therefore, a need exists for a way to tag an interaction as a long-living interaction, so that contextual data pertaining to the interaction is linked to the interaction or series of interactions.

### SUMMARY

Embodiments in accordance with the present invention may provide a method to preserve a long-lived interaction, the method including: participating, by use of a communication medium, in a present communication session with a remote party; associating, by use of a processor, a present identification tag with the present communication session; associating, by use if a processor, contextual information with the present identification tag, wherein the contextual information provides context of the present communication session; and storing, by use if a processor coupled to a memory, a record of the present identification tag and contextual information beyond conclusion of the present communication session, wherein the stored present identification tag and stored contextual information form the long-lived interaction. The method may further include searching a memory for previous identification tags of previous communication sessions with the remote party; and selecting, from a search result, a previous identification tag for use as the present communication tag.

Embodiments in accordance with the present invention may provide a system to preserve a long-lived interaction, the system including: an interface to a communication medium, the interface configured to support a present communication session with a remote party; a first processor configured to associate a present identification tag with the present communication session; a second processor configured to associate contextual information with the present identification tag, wherein the contextual information provides context of the present communication session; and a memory configured to store a record of the present identification tag and contextual information beyond conclusion of the present communication session, wherein the stored present identification tag and stored contextual information form the long-lived interaction. The system may further include a search module configured to search a memory for previous identification tags of previous communication sessions with the remote party; and a selection module configured to select, from a search result, a previous identification tag for use as the present communication tag.

The preceding is a simplified summary of embodiments of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 illustrates a functional diagram of a system in accordance with an embodiment of the present invention;

FIG. 2 illustrates at a high level of abstraction a method at a caller terminal, in accordance with an embodiment of the present invention;

FIG. 3 illustrates at a high level of abstraction a method at a callee terminal, in accordance with an embodiment of the present invention; and

FIG. 4 illustrates at a high level of abstraction a method for handling an ongoing call in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The disclosure will be illustrated below in conjunction with an exemplary communication system. Although well suited for use with, e.g., a system using a server(s) and/or database(s), the disclosure is not limited to use with any particular type of communication system or configuration of system elements. Those skilled in the art will recognize that the disclosed techniques may be used in any communication application in which it is desirable to utilize long-living interactions.

The exemplary systems and methods of this disclosure will also be described in relation to software, modules, and associated hardware. However, to avoid unnecessarily obscuring the present disclosure, the following description omits well-known structures, components and devices that may be shown in block diagram form, are well known, or are otherwise summarized.

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for exemplary purposes only and other examples may be employed in lieu of, or in combination with, the examples disclosed. It should also be noted the examples presented herein should not be construed as limiting of the scope of embodiments of the present invention, as other equally effective examples are possible and likely.

The terms “switch,” “server,” “contact center server,” or “contact center computer server” as used herein should be understood to include a Private Branch Exchange (“PBX”), an Automated Contact Distribution (“ACD”) system, an enterprise switch, or other type of telecommunications system switch or server, as well as other types of processor-based communication control devices such as, but not limited to, media servers, computers, adjuncts, and the like.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, the term “gateway” may generally comprise any device that sends and receives data between devices. For example, a gateway may comprise routers, switches, bridges, firewalls, other network elements, and the like, any and combination thereof.

As used herein, the term “transmitter” may generally comprise any device, circuit, or apparatus capable of transmitting an electrical signal.

The term “computer-readable medium” as used herein refers to any tangible storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

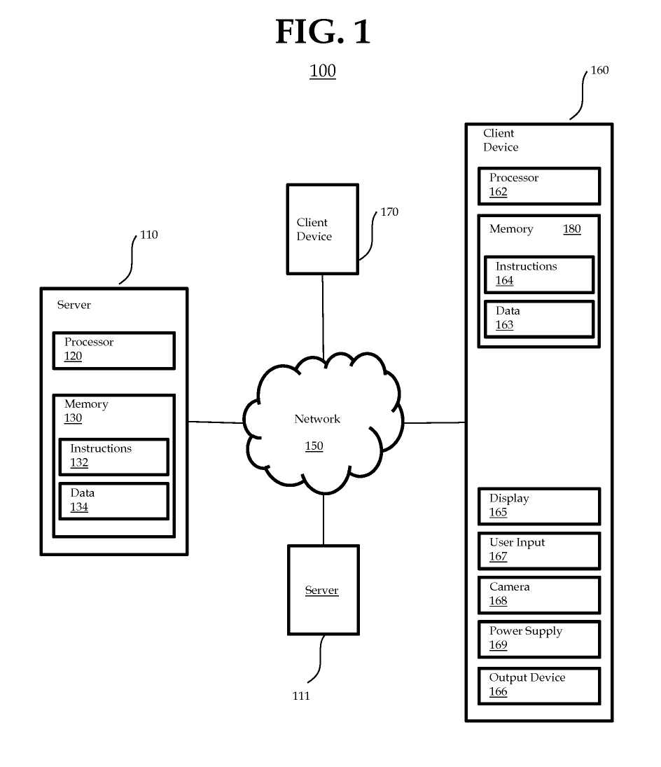

As shown in FIG. 1, a system 100 in accordance with one aspect of the present technology includes server 110 containing a processor 120, memory 130 and other components typically present in a communication device.

The server 110 may comprise one or more telecommunications devices that can provide data, video and/or audio services, such as, for example, a video server, a Private Branch Exchange (PBX), a switch, a web server, a security server, a key management server, or a network server or any other device capable of communicating data, bridging/mixing audio and/or video streams. Furthermore, server 110 may be at one node of a network 150 and may be capable of directly and indirectly receiving data from and sending data to other nodes of the network. For example, server 110 may be capable of receiving data from client device 160 via network 150 such that server 110 uses network 150 to transmit and display information to a user on display 165 of client device 170. Server 110 may also be operable to receive data from client device 160 via network 150 and transmit the data to one or more output devices such as, for example, speakers or one or more displays that are associated with server 110. Similarly, server 110 may, for example, comprise a web server that is capable of receiving data from a server 111 such that server 110 uses network 150 to transmit information to server 111. Differences in capability between different media devices (e.g., a camera whose resolution does not match a resolution of a viewing device) may be handled by use of techniques such as clipping, interpolation, decimation, codec conversions, etc.

Server 110 may also comprise a plurality of devices that exchange information with different nodes of a network for the purpose of receiving, processing and transmitting data to client devices. In this instance, the client devices will typically still be at different nodes of the network than any of the devices comprising server 110. Although server 110 is shown external to network 150, server 110 may be part of network 150.

System 100 may include a policy server that manages keys, document security level and can influence how the data is organized on client device 160. The policy server may also include a component that monitors the location of client device 160. The policy server may be integrated within server 110, or may be implemented as a separate server (not shown in FIG. 1) in communication contact with server 110 and client device 160 through network 150.

The memory 130 stores information accessible by processor 120, including instructions 132, and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, solid-state drive, memory card, flash drive, ROM, RAM, DVD or other optical disks, as well as other write-capable and read-only memories. In that regard, memory may include short term or temporary storage as well as long term or persistent storage. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the architecture is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless or lossy, and bitmap or vector-based, as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as any commercially available CPU. Alternatively, the processor may be a dedicated controller such as an ASIC. Although FIG. 1 functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor, a computer or a memory will be understood to include references to a collection of processors, computers or memories that may or may not operate in parallel.

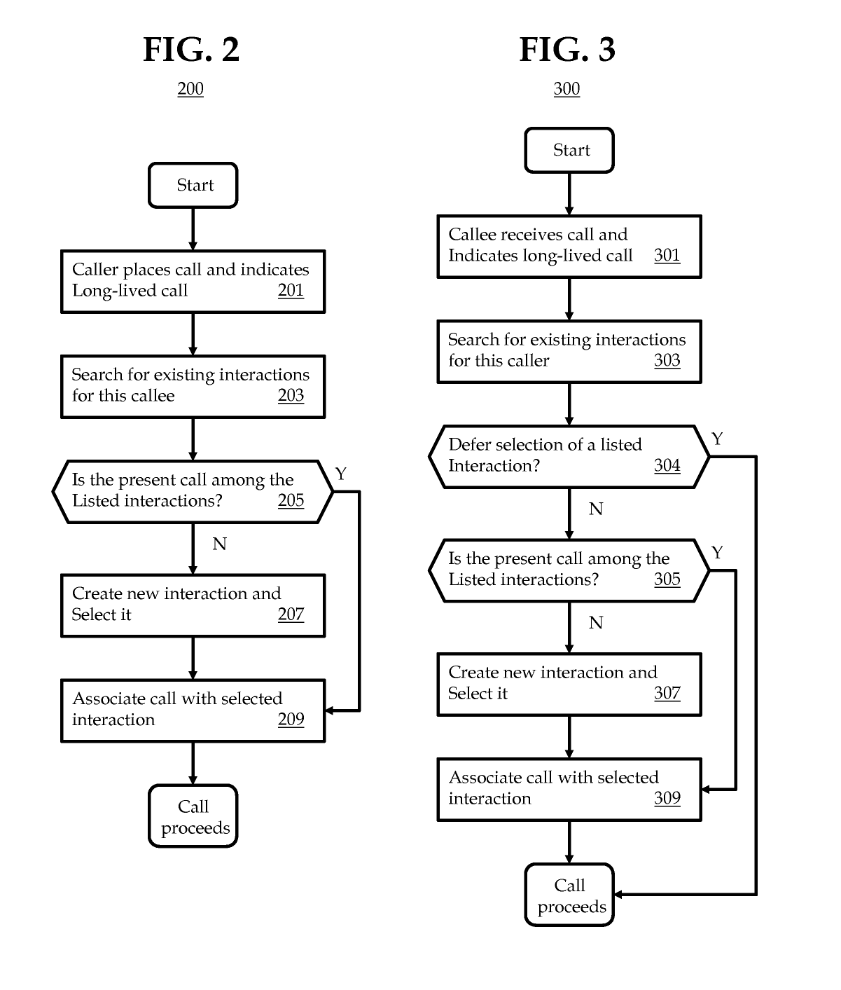

Network 150 may be any telecommunications network such as, for example, the Internet, a Wide Area Network (WAN), a Local Area Network (LAN), the Public Switched Telephone Network (PSTN), Bluetooth, Near Field Communication (NFC), WiFi, a cellular network, and an Integrated Digital Services Network (ISDN). Furthermore, network 150 may include one or more telecommunications networks with various configurations and may use various protocols such as, for example, VoIP, TCP/IP, proprietary protocols, instant messaging, HTTP and SMTP, and various combinations of the foregoing. Although only a few computers are depicted in FIGS. 1-2, it should be appreciated that a typical system can include a large number of connected computers.

Each client device 160 or 170 may be any type of telecommunications device that can output a video and/or audio stream, such as, for example, a telephone, a cellular telephone, a Personal Computer (PC), a Personal Digital Assistant (PDA), a tablet computer, a monitor, a television, or a conference room video system. Furthermore, each client device may be configured similarly to server 110, as described above, and may include various components such as, for example, a central processing unit (CPU) 162, memory 180 (e.g., RAM and internal hard drives) storing data 163 and instructions 164, an electronic display 165 (e.g., a monitor having a screen, a touch-screen, a projector, a television, a computer printer or any other electrical device that is operable to display information), output devices 166 (e.g., speaker, headset, headset connector), user input 167 (e.g., a mouse, keyboard, touch-screen or microphone), a camera 168, a power supply 169 (e.g., battery, AC adaptor connector, solar cell, or other power source), a network interface device, and all of the components used for connecting these elements to one another. Although shown as a single device, client devices 160 or 170 may be distributed between multiple devices. For example, client device 160 may be distributed between a telephone and a personal computer.

In addition to the operations described below and illustrated in the figures, various operations in accordance with aspects of the present technology will now be described. It should also be understood that the following operations do not have to be performed in the precise order described below. Rather, various steps can be handled in a different order or simultaneously. Steps may also be removed or added.

Embodiments in accordance with the present invention are able to tag an interaction as being a long-living interaction, thereby allowing substantially any contextual data pertaining to that interaction or series of interactions to be linked to the call. Once the contextual data is linked to the calls, a record of the calls and the associated contextual data become a part of a long-living interaction. Thereafter, when a user receives another call from a person associated with that interaction, the user is shown the linked contextual data along with context generation and capturing options.

Embodiments in accordance with the present invention are able to link contextual information across a series of interactions between the caller and the callee. The callee is a remote party to the caller, and the caller is a remote party to the callee. The parties may also be referred to as a remote party and a non-remote party. Substantially any contextual information (e.g., discussions, notes, documents, other files, etc.) can be linked to a long-lived interaction. The contextual information may be stored on a local file system of the user (i.e., the caller or callee) or stored on a server 110 that is accessible by both the caller and the callee. Embodiments in accordance with the present invention, for voice or video media streams, may share the media streams between the caller and the callee as a peer to peer connection, which may optionally be implemented using WebRTC. Signaling may be implemented in a variety of methods, such as Session Initiation Protocol (“SIP”, also known as RFC 3261), JavaScript Session Establishment Protocol (“JSEP”) over WebSockets, and so forth. DATA sharing may be implemented in a variety of methods, such as WebRTC Data Channel protocol, Websockets, and so forth.

Embodiments in accordance with the present invention are usable in a context of unified communications, outside of a contact center domain. Embodiments in accordance with the present invention are usable on a client device 160 such as a softphone, smartphone, tablet, PC, laptop, etc., having installed thereon a soft phone/call signaling application in accordance with an embodiment of the present invention.

Embodiments in accordance with the present invention add an identifying tag to a call to indicate that the call should be treated as a “long-living interaction.” Embodiments in accordance with the present invention may operate in a “standalone” mode or in a “shared” mode. When operating in the standalone mode, embodiments may be practiced independently by either the caller or callee, without coordination, so that one side but not necessarily the other side treats the call as a long-living interaction.

For example, of a standalone mode in accordance with an embodiment of the present invention, a user may want to create a long-living interaction with an investment advisor, in order to track investments and make informed decisions. However, the investment advisor may have a large number of such clients and therefore may not have a need to create such long-lived interactions with all of them. Therefore, a standalone mode used by just the user is appropriate.

In another example, of a shared mode in accordance with an embodiment of the present invention, a server may communicatively connect the caller and callee in order to share a long-lived interaction. Contextual information for the long-lived interaction may be stored on the server and may be accessible by all the members of the long-lived interaction. Any change or update of the contextual information is available to all the members.

In an exemplary usage of the shared mode, an employee may call a colleague. After the call is over, the employee may decide to create a long-lived interaction and tag the call to it. When the employee creates the long living interaction, information related to the call will be sent to the server, e.g., by using a data transmitting protocol such as HTTP/TCP. The server will send an ‘interaction invite’ to another party to the call (e.g., the remote colleague). If the remote party accepts the ‘interaction invite’ to the long-living interaction, the long-living interaction will now be available to the remote party along with access to all of the contextual data. If the remote party does not accept the invitation, then the call may still be available to the caller in standalone mode.

The identifying tag may take a different form depending on whether an embodiment of the invention is practiced in standalone mode in shared mode. In standalone mode, the identifying tag may be created and maintained in a data structure on the local machine. In shared mode, the identifying tag is created and maintained both on the server as well as on the client. The long-lived tag may be added in two ways:

First, if the call is being placed as a long-living interaction from the start (e.g., as a long-lived interaction in the client application), then a unique identifier of the long-lived interaction is stored as a tag in the call. The tag may be passed in an INVITE message in the SIP protocol. A client application at the callee end may be configured to search for a tag in the SIP INVITE message and matches it with the IDs of existing long-living interactions in the callee's client application. If a match is found, the corresponding long-lived interaction is identified and contextual information related to the interaction may be displayed before the call is answered and during the call.

Second, if no tag match is found, then the callee's client application may attempt to match the caller's number with existing long-living interactions that the callee has previously treated as a long-living interaction. If there are one or more matches, all the long-lived interactions are displayed to the callee. The callee may then answer the call and then decide which interaction to tag this call to. If there still is no match to a previous long-living interaction, then the callee may be asked whether to accept call with or without accepting an “interaction invite” to the interaction. The interaction invite is a message (separate from the SIP INVITE) which is sent by an application server to all invitees of a long-living interaction, asking whether the invitees want to join the interaction or not.

Embodiments in accordance with the present invention may also support an “Offline” mode. Offline mode may be useful when the server is temporarily inaccessible. In Offline mode, a tag along with a list of long-living interactions may be persistently stored on the local storage of each respective client, such that if the server is temporarily inaccessible, then the contextual information may still be used by the respective client in the same way. For example, the respective clients will still be able to distinguish calls and associate calls to existing long-living interactions, or to create new long-living interactions and tag calls to the new interactions in offline mode. Context capture and generation tools will continue to be available in offline mode. Later, when the server is again accessible, all information locally stored during offline mode will be synced with the server.

A long-living interaction that has been created in standalone mode may be upgraded for operation in shared mode. For example, a long-living interaction may have been created originally in standalone mode because complete infrastructure was not available to support shared mode. Later, the infrastructure may have been upgraded to include a sufficiently-capable server. The user thereafter may want to access and use the long-living interactions in shared mode. The user may import the long-living interactions from standalone mode to the shared mode, which then allows the imported long-living interactions to be shared across all members of the interaction (if they have chose to accept such interactions) without any additional steps. The user may set the “long-living interaction” tag at substantially any time, e.g., while making a call, while receiving a call, or after a call. This will create a new long-lived interaction between the caller and the callee. Once the user decides to tag his call as a long-lived call, various context generation/capturing options are displayed to the user so that the user can now link contextual data to this long-lived interaction. Linking (i.e., associating) is an action that a user can take, which may be used to add contextual data or to provide a link to existing contextual data present in the user's local file system or on the server.

For example, a user ordinarily maintains a contact list of other persons with whom the user has or expects to have multiple interactions. The multiple interactions may span a series of interactions on one subject or a small number of subjects (e.g., family issues, work issues, doctor visits, etc.). The user's interactions with persons in the contact list may be improved (e.g., made more efficient, reduce the number and pendency of unresolved issues, attend to follow-up issues, etc.) by keeping track of contextual information related to the calls. Storage of the contextual information may be in the file system of the user's client device 160 or on a server 110 that is accessible to both the caller as well as the callee.

Information may be stored on the server even if one party wants to keep the information private without sharing with another party. Contextual data or portions thereof (e.g., discussions, notes, instant message (“IM”) transcripts, etc.) may be tagged as “private” or “public.” Designation as private will cause the designated data to be visible only by the party who added the data. Designation as public will cause the designated data to be visible to all concerned parties. Optionally, for a multi-party long-lived interaction, a user may designate that the information be selectively visible only to predetermined members of the long-living interaction. Storage location depends on the implementation model. In the standalone operating mode, information added to a long-living interaction may be stored locally on the user's local storage, without the remote party knowing that the call is tagged to a long-lived interaction. In the shared operating mode (i.e., a client-server implementation), information added to a long-living interaction may be stored on the server as well as the client, with the remote party being notified that the call has been tagged to a long-living interaction.

In some circumstances there may be multiple long-living interactions between a particular caller and a particular callee. If so, then when the callee receives an alert of an incoming call, a list of long-living interactions with the caller (the caller being determined from the caller ID or the like) may be displayed by the callee's client device 160. If the caller is calling from within the context of the long-lived interaction using SIP signaling, then the SIP Invite message contains a tag of the long living interaction. If the tag is available, the callee may then search for the tag in existing long-living interactions that the callee is aware of, and if a match is found then the intended long-lived interaction is displayed at the callee's client device 160.

However, if there is no tag match, then a list of long-living interactions with the caller (as determined by caller ID or the like) may be displayed to the callee, and the callee may tag the call after answering the call and after having determined the subject matter of the call. After the call is over, the callee may also then tag the call as a long-living interaction.

In another embodiment in accordance with the present invention, if a caller creates a long-lived interaction before making a call and adds the callee as a member to the long-living interaction, then since there is no call in place, the invitation to engage in an established long-lived interaction is sent to members of the established long-lived interaction. The invitation may be sent over HTTP/TCP by using a custom message sent by the application server. The callee may then decide, before the call is placed, whether or not to accept the invitation to join in a long-lived interaction. The caller then makes the call from within the context of the long-living interaction. The callee receives the call and, if the callee had accepted the invitation to join in a long-lived interaction, the tag ID in the SIP INVITE will match with an existing long-living interaction, and the caller will be shown the intended interaction. For example, the caller's number may be matched with a telephone number in the callee's contact list or in a list configured by the callee as containing persons involved in long-lived interactions. A list of matching long-living interactions may be presented to the callee, and the callee may make a selection at that time or wait until later. If a call is unanswered on the callee's end (e.g., the call goes to voice mail), then if a long-living interaction tag has been found and matched, information related to the unanswered call may be added to the call log of the interaction on the callee's end as a missed call. Whether or not to add the recorded voice mail greeting to the interaction as context can be made a configurable parameter. The callee's recorded voice mail greeting may be useful contextual information to know why the callee was unavailable to attend to the call, for example if the greeting indicates that the callee is out of the office until a future date.

Furthermore, in some embodiments, it may make a difference if the users reverse roles, i.e., for calls between user “A” and user “B”, sometimes user “A” is the caller and sometimes user “B” is the caller. For example, in the shared operating mode, the person who creates a long-lived interaction is the originator. Though all concerned members of the interaction can view the interaction, the originator has more control over the interaction. Only the originator can decide to delete the long-lived interaction.

A callee may not know the purpose of a call until after the conversation begins. In this circumstance, the callee may defer selecting a long-living interaction to associate with the call. Once the purpose of the call becomes clear, the callee may then make an association of the call to a long-living interaction.

A callee may have made an initial selection of a long-living interaction, such as before answering the call or at the beginning of the call, and then discover that the selection of long-living interaction was incorrect, or a new topic is discussed during the call. In embodiments in accordance with the present invention, the user may be able to change (either prospectively or retroactively) the long-living interaction to which the call is associated, or to associate the call with another long-living interaction without deleting a previous long-living interaction association.

In some circumstances, the call may cover more than one subject matter, such as serially as with an agenda, or more intermingled as in a stream of consciousness discussion. In such circumstances, the callee may have an ability to assign the call or portions thereof to more than one long-living interaction, either serially (i.e., one at a time) or in parallel (i.e., the call or portion thereof pertains to more than one of the identified long-living interactions). The callee may have an ability later to change or otherwise edit the associations with the long-living interaction(s).

Processing performed on the callee end to associate the call with a long-living interaction may also be performed on the caller's end for the caller's benefit. One difference is that a user contemplating making a call may want to review or study a particular long-living interaction or list of long-living interactions in preparation for making a call. Another difference is that when the caller makes the call, the caller knows the purpose of the call and therefore is able to make an association with a long-living interaction before the callee answers the call. After the call is answered, processing in accordance with an embodiment of the present invention may proceed substantially the same on either the caller's end or the callee's end. Therefore, references herein to processing performed by the callee after the call is answered will also apply to processing performed by the caller, unless the context of the description clearly indicates otherwise.

Embodiments in accordance with the present invention are operable if only one party to the call (i.e., the caller or callee, but not both) implements the embodiments.

Once the call is associated with a long-living interaction, then the contextual data for that long-living interaction as previously indicated or saved by the user is retrieved and made accessible by the user for use during the call and later for post-call analysis. For example, the callee's system may retrieve the callee's contextual data when the callee makes a selection, and the caller's system would retrieve the caller's contextual data when the caller makes a selection.

After a call is complete the callee (or caller) may be able to go back and make or change the association of the call with a new or existing long-living interaction from a call log.

Embodiments in accordance with the present invention are usable with a variety of client devices 160. Embodiments are compatible with Bring Your Own Device (“BYOD”) operation. To support BYOD operation, embodiments provide for a mobile client device 160 (e.g., smartphone, tablet, etc.) to sync with a desktop telecommunications or computing client device 160, and for the desktop client device 160 to sync with the mobile client device 160. During the sync process, the mobile client device 160 may push contextual data to a desktop client device 160, and vice-versa. Syncing of data may be based on simple date/time/size file validations. Once the contextual data is pushed from a mobile device to desktop, the data will be accessible by a softphone used on the desktop client and vice-versa.

A software plug-in module for business productivity software such as Microsoft Outlook™ may be used to export contextual data (e.g., emails, calendar information, etc.) from the user's account on the desktop client to the long-lived interactions accessible by the mobile device, thereby providing contextual data for later discussions.

Embodiments allow for desktop clients and mobile clients to be customized to provide menu options to send contextual data (e.g., files and other documents) to a particular long-living interaction. For example, a Windows shell extension may be provided on a context menu of a folder, which provides an option labeled “Add to interaction . . . ” and which would be used to add the selected contextual data to the selected interaction.

Embodiments allow for a user to delete or purge a long-lived interaction if it is no longer in use. Optionally, a deleted long-lived interaction may be archived in server 110. A purged long-lived interaction is deleted permanently.

Embodiments in accordance with the present invention may allow for a document or portions thereof to be dynamically updated. Such an updateable document should be stored on the server, and the embodiments should be operating in a shared mode. Older versions of documents may also be retrieved, by use of version control of the documents on the server. For example, if a saved document includes historical stock price charts as part of a financial analysis, then one or more of the stock price charts may optionally be updated to current market conditions each time the saved document is accessed. Optionally, the information in the document, including historical price charts, may be locked to the information at the time the document was created, or may be updated only upon specific command from the user.

Embodiments in accordance with the present invention are not limited to telephone calls when providing contextual data for long-lived interaction. Embodiments may also be used in meetings, for example, in a live conferencing or a recurring meeting (e.g., a status review meeting) or the like in order to share contextual information and maintain the contextual data across a series of such meetings in order to maintain the context of the meetings.

FIG. 2 illustrates an embodiment of a method 200 in accordance with the present invention, in which a caller wishes to place a call to a callee as part of a long-lived interaction. Method 200 begins at step 201, at which the caller places a call and indicates that the call will be treated as part of a long-lived interaction. The indication may be made, for example, by activating a control (e.g., button, hotspot, etc.) on the caller's softphone user interface.

Next, at step 203, embodiments may search for existing interactions between the caller and the callee.

Next, at step 205, a list of existing interactions (if any) between the caller and the callee may be presented to the caller for inspection and/or selection. If the long-lived interaction that is the subject matter of the present call is not listed, including if no long-lived interactions presently exists between the caller and callee, then control of method 200 passes to step 207. Otherwise, if the subject matter of the long-lived interaction of the present call is listed, then the long-lived interaction is selected and control of method 200 passes to step 209.

At step 207, a new long-lived interaction is created and selected by the caller. Control of method 200 then passes to step 209.

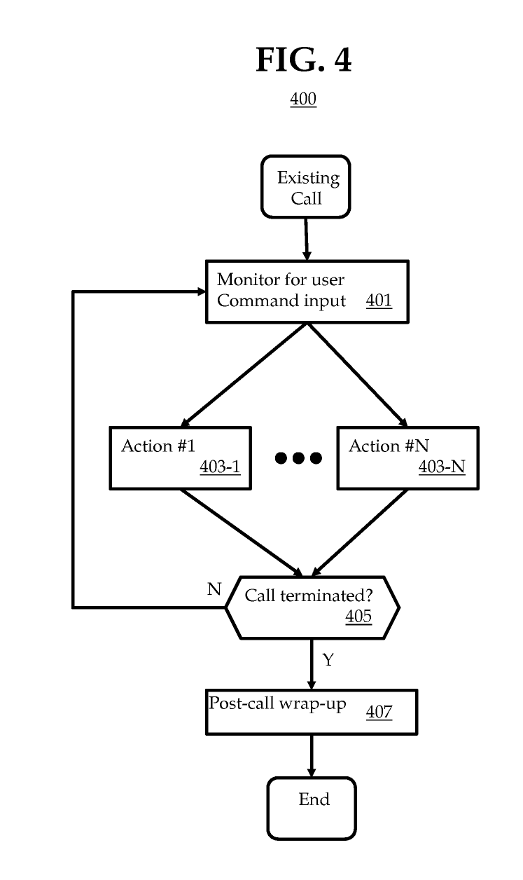

At step 209, the present call is associated with the selected long-lived interaction. Method 200 then ends, and control passes to proceeding with the call as illustrated by method 400 in FIG. 4.

FIG. 3 illustrates an embodiment of a method 300 in accordance with the present invention, in which a callee has received a call from a caller. Method 300 begins at step 301, at which the callee receives a call. Embodiments may initially treat an incoming call as if the callee will want to treat the call as part of a long-lived interaction. The indication may be made, for example, by activating a control (e.g., button, hotspot, etc.) on the callee's softphone user interface.

Next, at step 303, embodiments may search for existing interactions between the caller and the callee.

Next, at step 304, the callee may want to defer a selection of a listed long-lived interaction. For example, the callee may not know the purpose of the call. The callee may defer by simply answering the call, in which case method 300 then ends, and control passes to proceeding with the call as illustrated by method 400 in FIG. 4. If the callee wants to assign the call to a long-lived interaction at this time, then control of method 300 passes to step 305.

At step 305, a list of existing interactions (if any) between the caller and the callee may be presented to the callee for inspection and/or selection. If the long-lived interaction that is the subject matter of the present call is not listed, including if no long-lived interactions presently exists between the caller and callee, then control of method 300 passes to step 307. Otherwise, if the subject matter of the long-lived interaction of the present call is listed, then the long-lived interaction is selected and control of method 300 passes to step 309.

At step 307, a new long-lived interaction is created and selected by the caller. Control of method 300 then passes to step 309.

At step 309, the present call is associated with the selected long-lived interaction. Method 300 then ends, and control passes to proceeding with the call as illustrated by method 400 in FIG. 4.

FIG. 4 illustrates an embodiment of a method 400 in accordance with the present invention, in which a call has already been established between a caller and a callee. Method 400 may be practiced by either a caller or a callee (generically, a user). Method 400 may also be practiced in parallel with other processes or methods (not shown in FIG. 4) such as call management and device management. Method 400 begins with a call already in progress. The call may not already be designated as a long-lived interaction, for instance if the callee decided to defer treating it as a long-lived interaction. At step 401, the user's telecommunication device monitors substantially continuously for a command input (e.g., button press, hotkey, hotspot activation, menu selection, spoken command, pointer click, etc.). Upon detection of a command, control of method 400 passes to one of steps 403-1 through 403-N (collectively or individually generic, “step 403”).

At step 403, an action may be taken depending upon the command inputted at step 401. For example, actions may include: starting, stopping, or adding an association of the present call with a long-lived interaction; changing the long-lived interaction category for the present call; changing a property of the long-lived interaction (e.g., a title); linking to the long-lived interaction substantially any related contextual data like emails, word, excel, text documents, etc.; linking links of such documents to the long-lived interaction, such as links to files, URLs, links to SMS messages, and so forth; adding and storing new notes; capturing image, video, and/or audio; managing a display of available long-lived interactions (e.g., sorting, filtering, viewing attachments; examining call logs); and so forth.

Step 403 may also include initiating a child process which continues operating in parallel with method 400. For example, step 403 may include initiating a recording application that continues while the call is in progress; or step 403 may include opening a text capture tool so that the user can take notes during the call; and so forth.

Next, at step 405, a determination is made whether the call is done. For example, one of the possible actions under steps 403-1 through 403-N, or under an unillustrated parallel process or method, may have been to terminate the call. If the call is not terminated, then control of method 400 passes to step 401. If the call is terminated, then control of method 400 transfers to step 407

At step 407, post-call wrap-up may be performed. For example, the user may open an application to process information gathered or learned during the call; files may be closed and saved; attachments may be detached and saved in appropriate folders; and so forth.

Usage of system 100 may be illustrated by an example: A user (i.e., a patient) may want to tag a call to their doctor as a long-lived call. Once the user (i.e., caller) tags the call, the user's client device 160 establishes a processing thread, such that data (e.g., reports, files, prescriptions, emails, etc.) may be associated with and stored for that interaction. Thereafter, when the user calls their doctor the next time, the user has access to links to all the contextual information stored for that long-lived interaction. The advantage to both the doctor and the patient is that one or both users do not need to find the reference materials associated with the interaction. Instead, the reference materials are made accessible to them in the form of contextual information that they had previously added to the long-lived interaction sometime during the lifecycle of this long-lived interaction.

Embodiments of the present invention include a system having one or more processing units coupled to one or more memories. The one or more memories may be configured to store software that, when executed by the one or more processing unit, allows practicing the embodiments described herein, at least by use of processes described herein, including at least in FIGS. 2-4, and related text.

The disclosed methods may be readily implemented in software, such as by using object or object-oriented software development environments that provide portable source code that can be used on a variety of computer or workstation platforms. Alternatively, the disclosed system may be implemented partially or fully in hardware, such as by using standard logic circuits or VLSI design. Whether software or hardware may be used to implement the systems in accordance with various embodiments of the present invention may be dependent on various considerations, such as the speed or efficiency requirements of the system, the particular function, and the particular software or hardware systems being utilized.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention. Certain exemplary embodiments may be identified by use of an open-ended list that includes wording to indicate that the list items are representative of the embodiments and that the list is not intended to represent a closed list exclusive of further embodiments. Such wording may include “e.g.,” “etc.,” “such as,” “for example,” “and so forth,” “and the like,” etc., and other wording as will be apparent from the surrounding context.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A method to preserve a long-lived interaction, comprising:
participating, by use of a communication medium, in a present communication session with a remote party;
associating, by use of a processor, a present identification tag with the present communication session;
associating, by use if a processor, contextual information with the present identification tag, wherein the contextual information provides context of the present communication session; and
storing, by use if a processor coupled to a memory, a record of the present identification tag and contextual information beyond conclusion of the present communication session, wherein the stored present identification tag and stored contextual information form the long-lived interaction.

2. The method of claim 1, further comprising:
searching a memory for previous identification tags of previous communication sessions with the remote party; and
selecting, from a search result, a previous identification tag for use as the present communication tag.

3. The method of claim 1, wherein the step of associating is performed by a caller.

4. The method of claim 1, wherein the step of associating is performed by a callee.

5. The method of claim 1, wherein the step of associating is performed during the present communication session.

6. The method of claim 1, further comprising the step of changing a previous association of the contextual information during the present communication session.

7. The method of claim 1, wherein the step of associating is performed by a caller before initiation of the present communication session.

8. The method of claim 1, wherein the step of associating is performed after end of the present communication session.

9. The method of claim 1, further comprising the step of extending an interaction invitation to another party of the present communication session after end of the present communication session.

10. The method of claim 1, wherein the associated data is stored on a file system local to one of a caller and a callee.

11. The method of claim 1, wherein the associated data is stored on a server that is accessible by both a caller and a callee.

12. The method of claim 11, further comprising the step of designating the associated data stored on the server as one of public data and private data.

13. The method of claim 11, further comprising the step of dynamically updating the associated data is stored on the server.

14. The method of claim 1, wherein the long-lived interaction further comprises a peer-to-peer media stream.

15. The method of claim 1, wherein the present identification tag comprises a field of a Session Initiation Protocol (SIP) Invite message.

16. A system to preserve a long-lived interaction, comprising:
an interface to a communication medium, the interface configured to support a present communication session with a remote party;
a first processor configured to associate a present identification tag with the present communication session;
a second processor configured to associate contextual information with the present identification tag, wherein the contextual information provides context of the present communication session; and
a memory configured to store a record of the present identification tag and contextual information beyond conclusion of the present communication session, wherein the stored present identification tag and stored contextual information form the long-lived interaction.

17. The system of claim 16, further comprising:
a search module configured to search a memory for previous identification tags of previous communication sessions with the remote party; and
a selection module configured to select, from a search result, a previous identification tag for use as the present communication tag.
